(19) United States
(12) Patent Application Publication
(10) Pub. No.: US 2025/0078803 A1
(43) Pub. Date: Mar. 6, 2025

(54) ACTIVE NOISE REDUCTION SYSTEM

(71) Applicant: HONDA MOTOR CO., LTD., Tokyo (JP)

(72) Inventors: Xun WANG, Saitama (JP); Toshio INOUE, Saitama (JP)

(21) Appl. No.: 18/819,719

(22) Filed: Aug. 29, 2024

(30) Foreign Application Priority Data
Sep. 5, 2023 (JP) 2023-143602

(51) Int. Cl. G10K 11/178

(52) U.S. Cl. CPC G10K 11/17854; G10K 11/17879

(57) ABSTRACT

An active noise reduction system includes an error microphone configured to generate an error signal, and a controller configured to control a speaker based on the error signal. The controller includes a control filter configured to generate a control signal, a secondary path filter that represents an estimation value of a transfer function of a secondary path, and a correction filter that represents a difference between acoustic characteristics at a position of the error microphone and acoustic characteristics at a position of a user. The controller is configured to generate a correction signal by the correction filter, generate a correction error signal by correcting the error signal using the correction signal, generate a canceling sound estimation signal by the secondary path filter based on the control signal, and adaptively update the secondary path filter based on the canceling sound estimation signal and the correction error signal.

### TECHNICAL FIELD

The present invention relates to an active noise reduction system that reduces a noise by causing a canceling sound that is in an opposite phase to the noise to interfere with the noise.

### BACKGROUND ART

In recent years, taking into account people in vulnerable situations such as the elderly and children among traffic participants, efforts have been actively made to provide access to sustainable transportation systems for such people. Toward its realization, research and development for further improving the safety and convenience of traffic through development of vehicle comfort are attracting attention.

To improve vehicle comfort, it is desirable to reduce the noise inside a vehicle. As such, research and development of an active noise reduction system, which reduces the noise by causing a canceling sound that is in an opposite phase to the noise to interfere with the noise, are actively conducted.

For example, Japanese Patent No. 7262899 discloses an active noise control system including a position detection device that detects a head position of a user. This active noise control system selects one of a plurality of auxiliary filters according to the head position of the user detected by the position detection device, corrects a microphone error signal (a signal picked up by a microphone) using the output of the selected auxiliary filter, updates a variable filter based on the corrected microphone error signal, and controls a speaker by the updated variable filter. In this way, by selecting one of the plurality of auxiliary filters according to the head position of the user, it becomes possible to perform noise reduction control that follows the change in the head position of the user.

However, the active noise control system of Japanese Patent No. 7262899 does not learn a transfer function of a secondary path from the speaker to the microphone. Accordingly, in a case where the transfer function of the secondary path changes due to opening/closing of a window and the like, it is not possible to perform noise reduction control that follows the change in the transfer function of the secondary path, which may reduce a noise reduction effect.

### SUMMARY OF THE INVENTION

In view of the above background, an object of the present invention is to provide an active noise reduction system that can enhance a noise reduction effect by performing noise reduction control that follows not only the change in a position of a user but also the change in a transfer function of a secondary path. Further, another object of the present invention is to contribute to the development of sustainable transportation systems.

To achieve such an object, one aspect of the present invention provides an active noise reduction system (1 and 81) comprising: a speaker (21) configured to output a canceling sound for canceling a noise; an error microphone (22) configured to generate an error signal (e) based on the noise and the canceling sound; and a controller (23 and 83) configured to control the speaker based on the error signal, wherein the controller includes: a control filter (W) configured to generate a control signal (u) for controlling the speaker; a secondary path filter (C\hat{ }) that represents an estimation value of a transfer function of a secondary path from the speaker to the error microphone; and a correction filter (ΔP\hat{ } and ΔC\hat{ }) that represents a difference between acoustic characteristics at a position of the error microphone and acoustic characteristics at a position of a user, and the controller is configured to generate a correction signal (x, x₁, and x₂) by the correction filter, generate a correction error signal (eₑₐᵣ) by correcting the error signal using the correction signal, adaptively update the control filter based on the correction error signal, generate a canceling sound estimation (y\hat{ }) signal by the secondary path filter based on the control signal, and adaptively update the secondary path filter based on the canceling sound estimation signal and the correction error signal.

According to this aspect, the controller generates the correction signal by the correction filter (the filter that represents the difference between the acoustic characteristics at the position of the error microphone and the acoustic characteristics at the position of the user), generates the correction error signal by correcting the error signal using the correction signal, and adaptively updates the control filter based on the correction error signal. Accordingly, it is possible to perform noise reduction control that follows the change in the position of the user, thereby enhancing a noise reduction effect at the position of the user. Further, the controller adaptively updates the secondary path filter based on the canceling sound estimation signal and the correction error signal. Accordingly, it is possible to perform noise reduction control that follows the change in the transfer function of the secondary path, thereby further enhancing the noise reduction effect.

In the above aspect, preferably, the controller further includes a primary path filter (P\hat{ }) that represents an estimation value of a transfer function of a primary path from a noise source to the error microphone, and the correction filter includes: a first correction filter (ΔP\hat{ }) corresponding to the primary path filter; and a second correction filter (ΔC\hat{ }) corresponding to the secondary path filter.

According to this aspect, the error signal is corrected using the correction signals generated by the first correction filter (the correction filter corresponding to the primary path filter) and the second correction filter (the correction filter corresponding to the secondary path filter), respectively. Accordingly, it is possible to more accurately follow the change in the position of the user as compared to a case where the error signal is corrected only using the correction signal generated by the correction filter corresponding to either the primary path filter or the secondary path filter. Accordingly, it is possible to further enhance the noise reduction effect at the position of the user.

To achieve such an object, one aspect of the present invention provides an active noise reduction system (101) comprising: a speaker (21) configured to output a canceling sound for canceling a noise; an error microphone (22) configured to generate an error signal (e) based on the noise and the canceling sound; and a controller (103) configured to control the speaker based on the error signal, wherein the controller includes: a control filter (W) configured to generate a control signal (u) for controlling the speaker; a secondary path filter (C\hat{ }) that represents an estimation value of a transfer function of a secondary path from the speaker to the error microphone; and a correction filter (ΔC\hat{ }) that represents a difference between acoustic characteristics at a position of the error microphone and acoustic characteristics at a position of a user, and the controller is configured to generate a correction signal (x₂) by the correction filter, generate a correction error signal (eₑₐᵣ) by correcting the error signal using the correction signal, acquire a reference signal (r) corresponding to the noise, generate a correction reference signal (rₓ) by the secondary path filter and the correction filter based on the reference signal, adaptively update the control filter based on the correction error signal and the correction reference signal, generate a canceling sound estimation signal (y\hat{ }) by the secondary path filter based on the control signal, and adaptively update the secondary path filter based on the canceling sound estimation signal.

According to this aspect, the controller generates the correction signal by the correction filter (the filter that represents the difference between the acoustic characteristics at the position of the error microphone and the acoustic characteristics at the position of the user), generates the correction error signal by correcting the error signal using the correction signal, and adaptively updates the control filter based on the correction error signal. Accordingly, it is possible to perform the noise reduction control according to the change in the position of the user, thereby enhancing the noise reduction effect at the position of the user. Further, the controller generates the correction reference signal by the secondary path filter and the correction filter based on the reference signal, and adaptively updates the control filter based on the correction reference signal. Accordingly, it is possible to more accurately perform the adaptive update of the control filter. Furthermore, the controller adaptively updates the secondary path filter based on the canceling sound estimation signal. Accordingly, it is possible to perform the noise reduction control that follows the change in the transfer function of the secondary path, thereby further enhancing the noise reduction effect.

In the above aspect, preferably, the controller is configured to generate a virtual error signal (eᵥ) based on the error signal and the canceling sound estimation signal, and adaptively update the secondary path filter such that the virtual error signal is minimized.

According to this aspect, the controller adaptively updates the secondary path filter based on the error signal rather than the correction error signal. Accordingly, the secondary path filter after the adaptive update thereof converges to the transfer function of the secondary path from the speaker to the error microphone, rather than the transfer function of the secondary path from the speaker to the position of an occupant. Accordingly, it is possible to more accurately estimate the transfer function of the secondary path from the speaker to the error microphone, thereby improving the stability of the noise reduction control.

To achieve such an object, one aspect of the present invention provides an active noise reduction system (121) comprising: a speaker (21) configured to output a canceling sound for canceling a noise; an error microphone (22) configured to generate an error signal (e) based on the noise and the canceling sound; and a controller (123) configured to control the speaker based on the error signal, wherein the controller includes: a control filter (W) configured to generate a control signal (u) for controlling the speaker; a secondary path filter (C\hat{ }) that represents an estimation value of a transfer function of a secondary path from the speaker to the error microphone; and a correction filter (μW, and K) that represents a difference between acoustic characteristics at a position of the error microphone and acoustic characteristics at a position of a user, and the controller is configured to generate a correction control signal (uₑₐᵣ) by correcting the control signal by the correction filter, output the correction control signal to the speaker, generate a canceling sound estimation signal (y\hat{ }) by the secondary path filter based on the correction control signal, and adaptively update the secondary path filter based on the canceling sound estimation signal.

According to this aspect, the controller generates the correction control signal by the correction filter (the filter that represents the difference between the acoustic characteristics at the position of the error microphone and the acoustic characteristics at the position of the user), and outputs the correction control signal to the speaker. Accordingly, it is possible to perform the noise reduction control that follows the change in the position of the user, thereby enhancing the noise reduction effect at the position of the user. Further, the controller adaptively updates the secondary path filter based on the canceling sound estimation signal. Accordingly, it is possible to perform the noise reduction control that follows the change in the transfer function of the secondary path, thereby further enhancing the noise reduction effect.

In the above aspect, preferably, the controller is configured to generate a correction error signal (e′) by removing a component of the correction filter from the error signal, and adaptively update the control filter based on the correction error signal.

According to this aspect, it is possible to prevent the value of the control filter after the adaptive update thereof from deviating from the original value due to the component of the correction filter included in the error signal. Accordingly, it is possible to more accurately perform the adaptive update of the control filter.

In the above aspect, preferably, the controller further includes a primary path filter that represents an estimation value of a transfer function of a primary path from a noise source to the error microphone, and the correction filter corresponds to both the primary path filter and the secondary path filter.

According to this aspect, using a single correction filter, it is possible to achieve the same noise reduction effect as a case where a correction filter corresponding to the primary path filter and a correction filter corresponding to the secondary path filter are used in combination. Further, as compared to a case where a correction filter corresponding to the primary path filter and a correction filter corresponding to the secondary path filter are provided separately, it is possible to save the memory capacity of the controller.

Thus, according to the above aspects, it is possible to provide an active noise reduction system that can enhance a noise reduction effect by performing noise reduction control that follows not only the change in a position of a user but also the change in a transfer function of a secondary path.

### BRIEF DESCRIPTION OF THE DRAWING(S)

FIG. 1 is a schematic diagram showing a vehicle to which an active noise reduction system according to the first embodiment is applied;

FIG. 2 is a functional block diagram showing the active noise reduction system according to the first embodiment;

FIG. 3 is an explanatory diagram illustrating a calculation method of a correction filter according to the first embodiment;

FIG. 4 is an explanatory diagram showing the difference between a transfer function of a microphone secondary path and a transfer function of an occupant secondary path according to the first embodiment;

FIG. 5 is a functional block diagram showing an active noise reduction system according to the second embodiment;

FIG. 6 is an explanatory diagram illustrating a calculation method of a first correction filter according to the second embodiment;

FIG. 7 is a functional block diagram showing an active noise reduction system according to the third embodiment;

FIG. 8 is a functional block diagram showing an active noise reduction system according to the fourth embodiment;

FIGS. 9A to 9C are explanatory diagrams illustrating an identification method of a correction filter according to the fourth embodiment; and

FIG. 10 is a functional block diagram showing an active noise reduction system according to another embodiment.

### DETAILED DESCRIPTION OF THE INVENTION

In the following, embodiments of the present invention will be described with reference to the drawings. Note that in the following description, “\hat{ }” (circumflex) added to various symbols indicates an identified value or an estimated value. “\hat{ }” is added above each symbol in the drawings, but is added after each symbol in the description.

### The First Embodiment

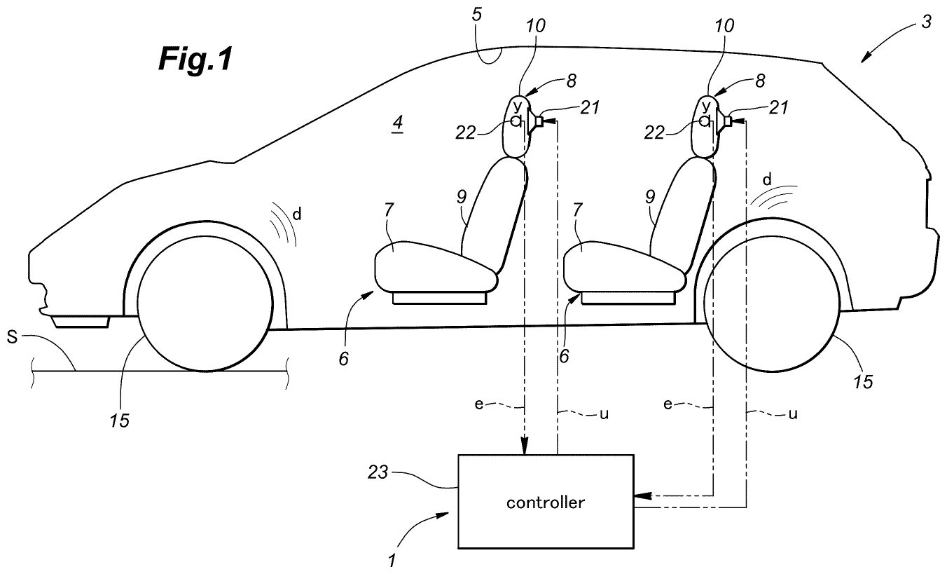

First, the first embodiment of the present invention will be described with reference to FIGS. 1 to 4.

### <Vehicle 3>

FIG. 1 is a schematic diagram showing a vehicle 3 to which an active noise reduction system 1 (hereinafter referred to as “the noise reduction system 1”) according to the first embodiment is applied. The vehicle 3 is, for example, a four-wheeled automobile.

Inside a vehicle cabin 4 of the vehicle 3, a plurality of occupant seats 6 is arranged below a roof lining 5. Each occupant seat 6 (hereinafter simply referred to as “the occupant seat 6”) includes a seat cushion 7 and a reclining portion 8 arranged above and behind the seat cushion 7 and configured to rotate relative to the seat cushion 7. The reclining portion 8 includes a seat back 9 and a headrest 10 fixed to an upper end of the seat back 9.

### <Noise Reduction System 1>

The noise reduction system 1 is an Active Noise Control device (ANC device) configured to reduce a noise d generated inside the vehicle cabin 4 of the vehicle 3. More specifically, the noise reduction system 1 reduces the noise d by generating a canceling sound y that is in an opposite phase to the noise d and causing the generated canceling sound y to interfere with the noise d.

For example, the noise d to be reduced by the noise reduction system 1 is a road noise caused by the vibrations of wheels 15 due to the force from a road surface S. The noise d to be reduced by the noise reduction system 1 may be a noise (for example, a drive noise caused by the vibrations of a drive source such as an internal combustion engine and an electric motor) other than the above-mentioned road noise.

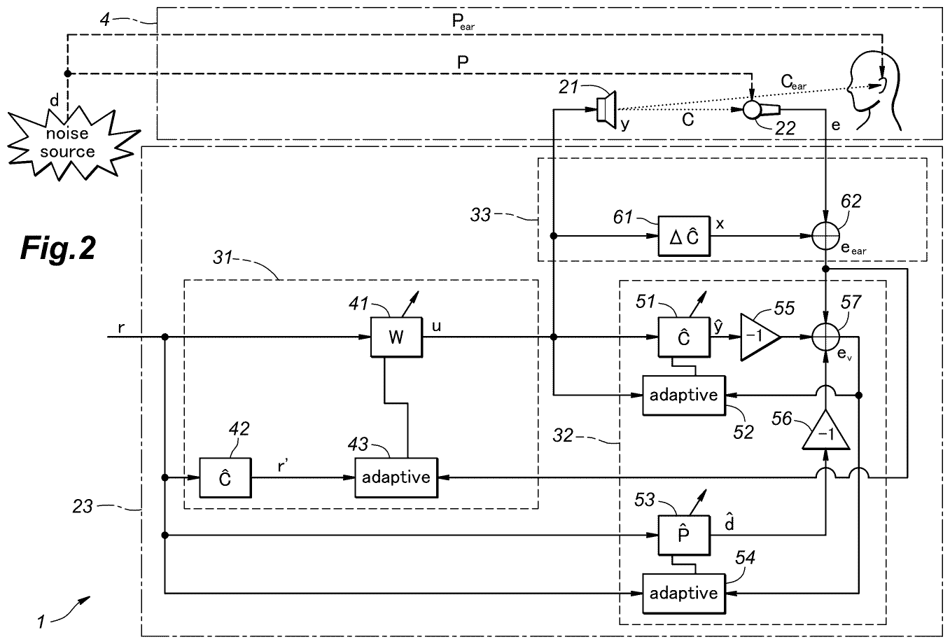

With reference to FIGS. 1 and 2, the noise reduction system 1 includes a plurality of speakers 21 each configured to output the canceling sound y for canceling the noise d, a plurality of error microphones 22 each configured to generate an error signal e based on the noise d and the canceling sound y, and a controller 23 configured to control the plurality of speakers 21 based on the error signal e.

### <Speaker 21>

With reference to FIG. 1, each speaker 21 (hereinafter simply referred to as “the speaker 21”) is installed in the headrest 10 of the reclining portion 8 of the occupant seat 6. In another embodiment, the speaker 21 may be installed in a portion (for example, the seat back 9) other than the headrest 10 of the reclining portion 8 of the occupant seat 6, or in a portion other than the reclining portion 8 of the occupant seat 6. In still another embodiment, the speaker 21 may be installed in a portion of the vehicle 3 other than the occupant seat 6.

### <Error Microphone 22>

Each error microphone 22 (hereinafter simply referred to as “the error microphone 22”) is provided in the headrest 10 of the reclining portion 8 of the occupant seat 6. In another embodiment, the error microphone 22 may be provided in a portion (for example, the seat back 9) of the reclining portion 8 of the occupant seat 6 other than the headrest 10, or in a portion of the occupant seat 6 other than the reclining portion 8. Further, in another embodiment, the error microphone 22 may be provided in a portion of the vehicle 3 other than the occupant seat 6.

“C” in FIG. 2 represents a transfer function of a secondary path (hereinafter referred to as “the microphone secondary path”) from the speaker 21 to the error microphone 22, and “Cₑₐᵣ” in FIG. 2 represents a transfer function of a secondary path (hereinafter referred to as “the occupant secondary path”) from the speaker 21 to an ear position of an occupant (an example of a user). “P” in FIG. 2 represents a transfer function of a primary path (hereinafter referred to as “the microphone primary path”) from a noise source to the error microphone 22, and “Pₑₐᵣ” in FIG. 2 represents a transfer function of a primary path (hereinafter referred to as “the occupant primary path”) from the noise source to the ear position of the occupant. The transfer function C of the microphone secondary path and the transfer function P of the microphone primary path represent acoustic characteristics at the position of the error microphone 22, and the transfer function Cₑₐᵣ of the occupant secondary path and the transfer function Pₑₐᵣ of the occupant primary path represent acoustic characteristics at the ear position of the occupant.

### <Controller 23>

The controller 23 is composed of a computer including an arithmetic processing unit (a processor such as a CPU, an MPU, etc.) and a storage device (a memory such as a ROM, a RAM, etc.). The controller 23 may be configured as one piece of hardware or may be configured as a unit including multiple pieces of hardware.

The controller 23 acquires a reference signal r corresponding to the noise d. For example, the reference signal r is input to the controller 23 from an acceleration sensor (not shown) located on a suspension of the vehicle 3. In another embodiment, the reference signal r may be input to the controller 23 from a reference microphone (not shown) that generates the reference signal r from the noise d, or may be input to the controller 23 from a component other than the acceleration sensor or the reference microphone.

With reference to FIG. 2, the controller 23 includes, as functional components thereof, a control signal generation unit 31, a sound field learning unit 32, and an error signal correction unit 33.

### <Control Signal Generation Unit 31>

The control signal generation unit 31 of the controller 23 includes a control filter unit 41, a secondary path filter unit 42, and a control update unit 43.

The control filter unit 41 includes a control filter W. The control filter W is composed of, for example, a finite impulse response filter (FIR filter). In another embodiment, the control filter W may be composed of a single-frequency adaptive notch filter (SAN filter) and the like.

The control filter unit 41 applies a filtering process to the reference signal r by the control filter W, thereby generating a control signal u for controlling the speaker 21. The control filter unit 41 outputs the generated control signal u to the speaker 21, the sound field learning unit 32, and the error signal correction unit 33. Accordingly, the speaker 21 generates the canceling sound y according to the control signal u output from the control filter unit 41.

The secondary path filter unit 42 includes a secondary path filter C\hat{ }. The secondary path filter C\hat{ } is a filter that represents an estimation value of the transfer function C of the microphone secondary path. The secondary path filter C\hat{ } is composed of, for example, an FIR filter. In another embodiment, the secondary path filter C\hat{ } may be composed of a SAN filter and the like.

The secondary path filter unit 42 applies a filtering process to the reference signal r by the secondary path filter C\hat{ }, thereby generating a correction reference signal r′. The secondary path filter unit 42 outputs the generated correction reference signal r′ to the control update unit 43.

The control update unit 43 adaptively updates the control filter W based on the correction reference signal r′ output from the secondary path filter unit 42 and a correction error signal eₑₐᵣ (which will be described later) output from the error signal correction unit 33. More specifically, the control update unit 43 adaptively updates the control filter W using an adaptive algorithm such as an LMS algorithm (Least Mean Square algorithm) such that the correction error signal eₑₐᵣ is minimized.

### <Sound Field Learning Unit 32>

The sound field learning unit 32 of the controller 23 includes a canceling sound estimation signal generation unit 51, a secondary path update unit 52, a noise estimation signal generation unit 53, a primary path update unit 54, a canceling sound estimation signal reversing unit 55, a noise estimation signal reversing unit 56, and an adder 57.

The canceling sound estimation signal generation unit 51 includes the secondary path filter C\hat{ }, similar to the secondary path filter unit 42. When the secondary path filter C\hat{ } is updated in the canceling sound estimation signal generation unit 51, the updated secondary path filter C\hat{ } is output to the secondary path filter unit 42, and the secondary path filter C\hat{ } is updated in the secondary path filter unit 42. That is, the secondary path filter C\hat{ } set in the secondary path filter unit 42 is not a fixed value, but a value that is successively updated based on the signal from the canceling sound estimation signal generation unit 51.

The canceling sound estimation signal generation unit 51 applies a filtering process to the control signal u by the secondary path filter C\hat{ }, thereby generating a canceling sound estimation signal y\hat{ } that represents an estimation value of the canceling sound y. The canceling sound estimation signal generation unit 51 outputs the generated canceling sound estimation signal y\hat{ } to the canceling sound estimation signal reversing unit 55.

The secondary path update unit 52 adaptively updates the secondary path filter C\hat{ } based on the control signal u output from the control filter unit 41 and a virtual error signal eᵥ (which will be described later) output from the adder 57. More specifically, the secondary path update unit 52 adaptively updates the secondary path filter C\hat{ } using an adaptive algorithm such as the LMS algorithm such that the virtual error signal eᵥ is minimized.

The noise estimation signal generation unit 53 includes a primary path filter P\hat{ }. The primary path filter P\hat{ } is a filter that represents an estimation value of the transfer function P of the microphone primary path. The primary path filter P\hat{ } is composed of, for example, an FIR filter. In another embodiment, the primary path filter P\hat{ } may be composed of a SAN filter and the like.

The noise estimation signal generation unit 53 applies a filtering process to the reference signal r by the primary path filter PA, thereby generating a noise estimation signal d\hat{ } that represents an estimation value of the noise d. The noise estimation signal generation unit 53 outputs the generated noise estimation signal d\hat{ } to the noise estimation signal reversing unit 56.

The primary path update unit 54 adaptively updates the primary path filter P\hat{ } based on the reference signal r and the virtual error signal eᵥ (which will be described later) output from the adder 57. More specifically, the primary path update unit 54 adaptively updates the primary path filter P\hat{ } using an adaptive algorithm such as the LMS algorithm such that the virtual error signal eᵥ is minimized.

The canceling sound estimation signal reversing unit 55 reverses the polarity of the canceling sound estimation signal y\hat{ } output from the canceling sound estimation signal generation unit 51. The canceling sound estimation signal reversing unit 55 outputs the canceling sound estimation signal y\hat{ } with the reversed polarity to the adder 57.

The noise estimation signal reversing unit 56 reverses the polarity of the noise estimation signal d\hat{ } output from the noise estimation signal generation unit 53. The noise estimation signal reversing unit 56 outputs the noise estimation signal d\hat{ } with the reversed polarity to the adder 57.

The adder 57 generates the virtual error signal eᵥ by adding together the canceling sound estimation signal y\hat{ } that has passed through the canceling sound estimation signal reversing unit 55, the noise estimation signal d\hat{ } that has passed through the noise estimation signal reversing unit 56, and the correction error signal eₑₐᵣ (which will be described later) output from the error signal correction unit 33. The adder 57 outputs the generated virtual error signal eᵥ to the secondary path update unit 52 and the primary path update unit 54.

### <Error Signal Correction Unit 33>

The error signal correction unit 33 of the controller 23 includes a correction filter unit 61 and an adder 62.

The correction filter unit 61 includes a correction filter ΔC\hat{ }. The correction filter ΔC\hat{ } is a filter that represents a difference between an estimation value of the transfer function C of the microphone secondary path and an estimation value of the transfer function Cₑₐᵣ of the occupant secondary path. That is, the correction filter ΔC\hat{ } is a filter corresponding to the secondary path filter C\hat{ }, and is a filter that represents a difference between the acoustic characteristics at the position of the error microphone 22 and the acoustic characteristics at the ear position of the occupant. The correction filter ΔC\hat{ } is composed of, for example, an FIR filter. In another embodiment, the correction filter ΔC\hat{ } may be composed of a SAN filter and the like. The correction filter ΔC\hat{ } is a fixed value that is calculated in advance.

The correction filter unit 61 applies a filtering process to the control signal u by the correction filter ΔC\hat{ }, thereby generating a correction signal x. The correction filter unit 61 outputs the generated correction signal x to the adder 62.

The adder 62 generates the correction error signal eₑₐᵣ (the error signal at the ear position of the occupant) by adding together the error signal e (the error signal at the position of the error microphone 22) output from the error microphone 22 and the correction signal x output from the correction filter unit 61. That is, the adder 62 generates the correction error signal eₑₐᵣ by correcting the error signal e using the correction signal x. The adder 62 outputs the generated correction error signal eₑₐᵣ to the control signal generation unit 31 and the sound field learning unit 32.

### <The Calculation Method of the Correction Filter ΔC\hat{ }>

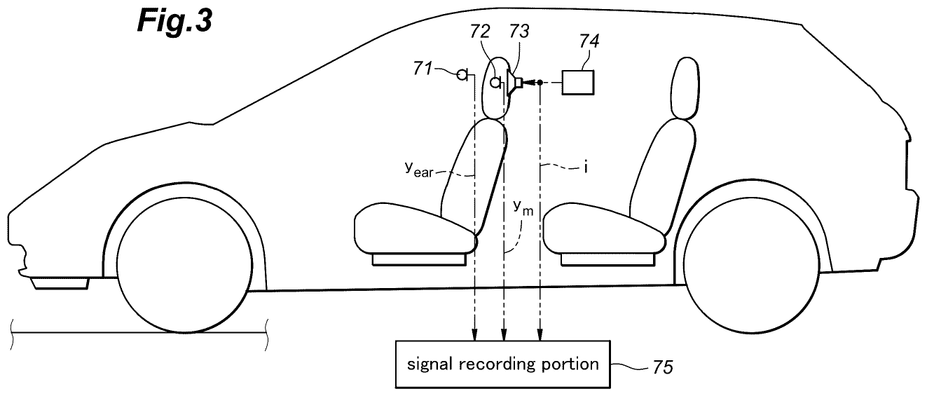

Next, an example of the calculation method of the correction filter ΔC\hat{ } will be described with reference to FIG. 3. When calculating the correction filter ΔC\hat{ }, a first measuring microphone 71 is arranged at a position corresponding to the ear position of the occupant, a second measuring microphone 72 is arranged at a position corresponding to the error microphone 22, and a measuring speaker 73 is arranged at a position corresponding to the speaker 21.

First, an identification sound signal i is input from a signal input device 74 to the measuring speaker 73, thereby causing the measuring speaker 73 to output an identification sound (for example, a white noise). In this state, the identification sound signal i, an occupant canceling sound signal year measured by the first measuring microphone 71, and a microphone canceling sound signal yₘ measured by the second measuring microphone 72 are recorded in a signal recording portion 75.

Next, a learning process using an adaptive algorithm is performed to calculate the estimation value of the transfer function Cₑₐᵣ of the occupant secondary path and the estimation value of the transfer function C of the microphone secondary path based on the identification sound signal i, the occupant canceling sound signal year, and the microphone canceling sound signal yₘ recorded in the signal recording portion 75. Further, the correction filter ΔC\hat{ } is calculated by subtracting the estimation value of the transfer function C of the microphone secondary path from the estimation value of the transfer function Cₑₐᵣ of the occupant secondary path. The correction filter ΔC\hat{ } is represented by the following formula (1).

$$Δ \hat{C} = {\hat{C}}_{e a r} - \hat{C} \qquad ( 1 )$$

### <Action and Effect>

The error signal e is a signal generated by adding together the canceling sound y and the noise d. Accordingly, the error signal e is represented by the following formula (2).

$$e = d + y = d + u * C \qquad ( 2 )$$

The correction error signal eₑₐᵣ is a signal generated by adding together the error signal e and the correction signal x. Further, the correction signal x is a signal generated by applying a filtering process to the control signal u by the correction filter ΔC\hat{ }. Accordingly, the correction error signal eₑₐᵣ is represented by the following formula (3).

$${e}_{e a r} = e + x = e + u * Δ \hat{C} \qquad ( 3 )$$

From the above formulae (1) to (3), the following formula (4) is acquired.

$${e}_{e a r} = d + u * C + u * {\hat{C}}_{e a r} - u * \hat{C} \qquad ( 4 )$$

Further, the following formula (5) is acquired from the above formula (4).

$${e}_{ear} = d + u * {\hat{C}}_{ear} \approx {\hat{d}}_{ear} + {\hat{y}}_{ear} \qquad ( 5 )$$

As shown in the above formula (5), the correction error signal eₑₐᵣ is an estimation value of a sound pressure after noise reduction control at the ear position of the occupant. Accordingly, by adaptively updating the control filter W such that the correction error signal eₑₐᵣ is minimized, the estimation value of the sound pressure after the noise reduction control at the ear position of the occupant is also minimized. Accordingly, it is possible to effectively reduce the noise d at the ear position of the occupant.

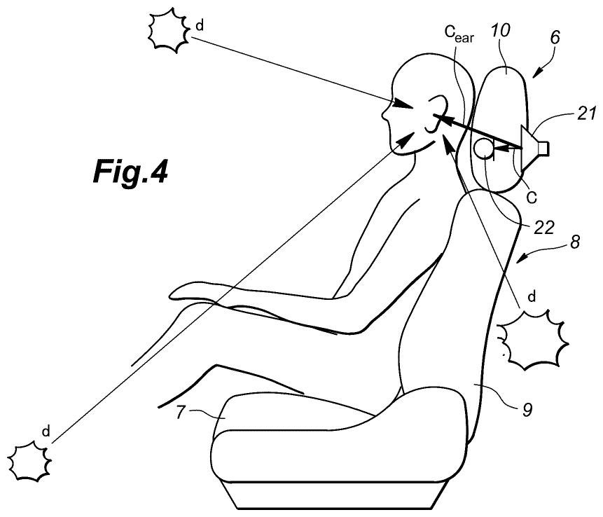

With reference to FIG. 4, particularly in the present embodiment, since both the speaker 21 and the error microphone 22 are positioned in the headrest 10 of the occupant seat 6, the distance from the speaker 21 to the error microphone 22 is short. In this regard, there is a large difference between the transfer function C of the microphone secondary path and the transfer function Cₑₐᵣ of the occupant secondary path. Accordingly, the controller 23 corrects, using the correction filter ΔC\hat{ }, the difference between the transfer function C of the microphone secondary path and the transfer function Cₑₐᵣ of the occupant secondary path. Accordingly, it is possible to enhance the noise reduction effect at the ear position of the occupant.

On the other hand, when the noise d occurs, the entire vehicle cabin 4 vibrates due to the input from the road surface S. In this regard, if the distance from the speaker 21 to the error microphone 22 is short, the difference between the transfer function P of the microphone primary path and the transfer function Pₑₐᵣ of the occupant primary path is small. Accordingly, the controller 23 does not include a correction filter corresponding to the primary path filter P\hat{ }, and does not correct a difference between the transfer function P of the microphone primary path and the transfer function Pₑₐᵣ of the occupant primary path. Accordingly, it is possible to reduce the calculational load on the controller 23 as compared to a case where both the difference between the transfer function C of the microphone secondary path and the transfer function Cₑₐᵣ of the occupant secondary path and the difference between the transfer function P of the microphone primary path and the transfer function Pₑₐᵣ of the occupant primary path are corrected.

### Modifications

In the above first embodiment, the position of the occupant is the ear position of the occupant. In another embodiment, the position of the occupant may be a head position of the occupant, a seated position of the occupant, and the like. In other words, the position of the occupant may be any position as long as the position of the occupant is a position where the above occupant canceling sound signal year can be measured.

In the above first embodiment, the correction filter ΔC\hat{ } (the filter that represents the difference between the acoustic characteristics at the position of the error microphone 22 and the acoustic characteristics at the ear position of the occupant) is a filter that represents the difference between the estimation value of the transfer function C of the microphone secondary path and the estimation value of the transfer function Cₑₐᵣ of the occupant secondary path (ΔC\hat{ }=Cₑₐᵣ\hat{ }−C\hat{ }). In another embodiment, the correction filter ΔC\hat{ } may be a filter that represents the ratio of the estimation value of the transfer function Cₑₐᵣ of the occupant secondary path to the estimation value of the transfer function C of the microphone secondary path (ΔC\hat{ }=Cₑₐᵣ\hat{ }/C\hat{ }).

### The Second Embodiment

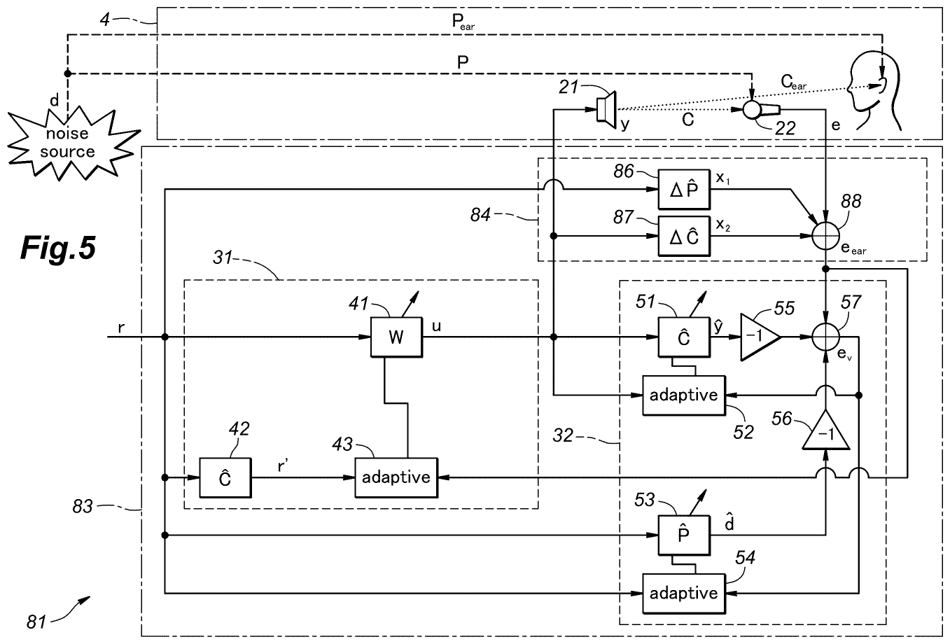

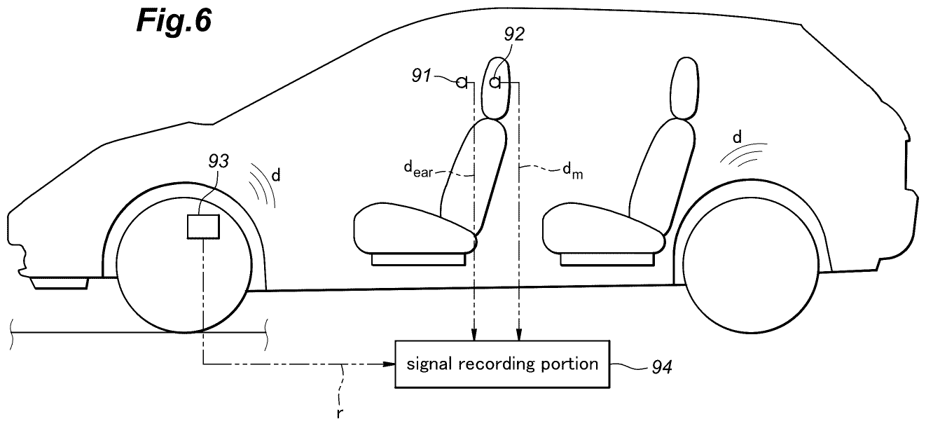

Next, an active noise reduction system 81 (hereinafter abbreviated as “the noise reduction system 81”) according to the second embodiment of the present invention will be described with reference to FIGS. 5 and 6. Since the components other than an error signal correction unit 84 of a controller 83 are similar to those in the first embodiment, these components will be given the same reference numerals as those in the first embodiment in the drawings, and the descriptions thereof will be omitted.

### <Error Signal Correction Unit 84>

The error signal correction unit 84 of the controller 83 includes a first correction filter unit 86, a second correction filter unit 87, and an adder 88.

The first correction filter unit 86 includes a first correction filter ΔP\hat{ }. The first correction filter ΔP\hat{ } is a filter that represents a difference between the estimation value of the transfer function P of the microphone primary path and the estimation value of the transfer function Pₑₐᵣ of the occupant primary path. That is, the first correction filter ΔP\hat{ } is a filter corresponding to the primary path filter P\hat{ }, and is a filter that represents a difference between the acoustic characteristics at the position of the error microphone 22 and the acoustic characteristics at the ear position of the occupant. The first correction filter ΔP\hat{ } is composed of, for example, an FIR filter. In another embodiment, the first correction filter ΔP\hat{ } may be composed of a SAN filter and the like. The first correction filter ΔP\hat{ } is a fixed value that is set in advance.

The first correction filter unit 86 applies a filtering process to the reference signal r by the first correction filter ΔP\hat{ }, thereby generating a first correction signal x₁. The first correction filter unit 86 outputs the generated first correction signal x₁ to the adder 88.

The second correction filter unit 87 includes a second correction filter ΔC\hat{ }. The second correction filter ΔC\hat{ } is similar to the correction filter ΔC\hat{ } according to the first embodiment, and therefore the descriptions thereof will be omitted. The second correction filter unit 87 applies a filtering process to the control signal u by the second correction filter ΔC\hat{ }, thereby generating a second correction signal x₂. The second correction filter unit 87 outputs the generated second correction signal x₂ to the adder 88.

The adder 88 generates a correction error signal eₑₐᵣ (the error signal at the ear position of the occupant) by adding together the error signal e (the error signal at the position of the error microphone 22) output from the error microphone 22, the first correction signal x₁ output from the first correction filter unit 86, and the second correction signal x₂ output from the second correction filter unit 87. In other words, the adder 88 generates the correction error signal eₑₐᵣ by correcting the error signal e using the first correction signal x₁ and the second correction signal x₂. The adder 88 outputs the generated correction error signal eₑₐᵣ to the control signal generation unit 31 and the sound field learning unit 32.

### <The Calculation Method of the First Correction Filter ΔP\hat{ }>

Next, an example of the calculation method of the first correction filter ΔP\hat{ } will be described with reference to FIG. 6. When calculating the first correction filter ΔP\hat{ }, a first measuring microphone 91 is arranged at a position corresponding to the ear position of the occupant, a second measuring microphone 92 is arranged at a position corresponding to the error microphone 22, and a reference signal output device 93 is arranged at a position corresponding to the noise source. The reference signal output device 93 is, for example, an acceleration sensor installed on a suspension.

First, the noise d (road noise) is generated by causing the vehicle 3 to travel. In this state, an occupant noise signal dₑₐᵣ measured by the first measuring microphone 91, a microphone noise signal dₘ measured by the second measuring microphone 92, and a reference signal r output from the reference signal output device 93 are recorded in a signal recording portion 94.

Next, a learning process using an adaptive algorithm is performed to calculate the estimation value of the transfer function Pₑₐᵣ of the occupant primary path and the estimation value of the transfer function P of the microphone primary path based on the reference signal r, the occupant noise signal dₑₐᵣ, and the microphone noise signal dₘ recorded in the signal recording portion 94. Further, the first correction filter ΔP\hat{ } is calculated by subtracting the estimation value of the transfer function P of the microphone primary path from the estimation value of the transfer function Pₑₐᵣ of the occupant primary path. The first correction filter ΔP\hat{ } is represented by the following formula (6).

$$Δ \hat{P} = {\hat{P}}_{ear} - \hat{P} \qquad ( 6 )$$

### <The Calculation Method of the Second Correction Filter ΔC\hat{ }>

The calculation method of the second correction filter ΔC\hat{ } is similar to the calculation method of the correction filter ΔC\hat{ } according to the first embodiment, and therefore the descriptions thereof will be omitted. The second correction filter ΔC\hat{ } is represented by the above formula (1), similarly to the correction filter ΔC\hat{ } according to the first embodiment.

### <Action and Effect>

The error signal e is a signal generated by adding together the canceling sound y and the noise d. Accordingly, the error signal e is represented by the following formula (7).

$$e = d + y = r * P + u * C \qquad ( 7 )$$

The correction error signal eₑₐᵣ is a signal generated by adding together the error signal e, the first correction signal x₁, and the second correction signal x₂. Further, the first correction signal x₁ is a signal generated by applying a filtering process to the reference signal r by the first correction filter ΔP\hat{ }, and the second correction signal x₂ is a signal generated by applying a filtering process to the control signal u by the second correction filter ΔC\hat{ }. Accordingly, the correction error signal eₑₐᵣ is represented by the following formula (8).

$${e}_{ear} = e + {x}_{1} + {x}_{2} = e + r * Δ \hat{P} + u * Δ \hat{C} \qquad ( 8 )$$

The following formula (9) is acquired from the above formula (1) and the above formulae (6) to (8).

$${e}_{ear} = r * P + u * C + r * {\hat{P}}_{ear} - r * \hat{P} + u * {\hat{C}}_{ear} - u * \hat{C} \qquad ( 9 )$$

Further, the following formula (10) is acquired from the above formula (9).

$${e}_{ear} = r * {\hat{P}}_{ear} + u * {\hat{C}}_{ear} = {\hat{d}}_{ear} + {\hat{y}}_{ear} \qquad ( 10 )$$

As shown in the above formula (10), the correction error signal eₑₐᵣ is an estimation value of a sound pressure after noise reduction control at the ear position of the occupant. Accordingly, by adaptively updating the control filter W such that the correction error signal eₑₐᵣ is minimized, the estimation value of the sound pressure after the noise reduction control at the ear position of the occupant is also minimized. Accordingly, it is possible to effectively reduce the noise d at the ear position of the occupant.

### Modifications

In the first embodiment, the error signal e is corrected by only the correction filter ΔC\hat{ } corresponding to the secondary path filter C\hat{ }. In the second embodiment, the error signal e is corrected by the first correction filter ΔP\hat{ } corresponding to the primary path filter P\hat{ } and the second correction filter ΔC\hat{ } corresponding to the secondary path filter C\hat{ }. In another embodiment, the error signal e may be corrected by only the correction filter ΔP\hat{ } corresponding to the primary path filter PA.

### The Third Embodiment

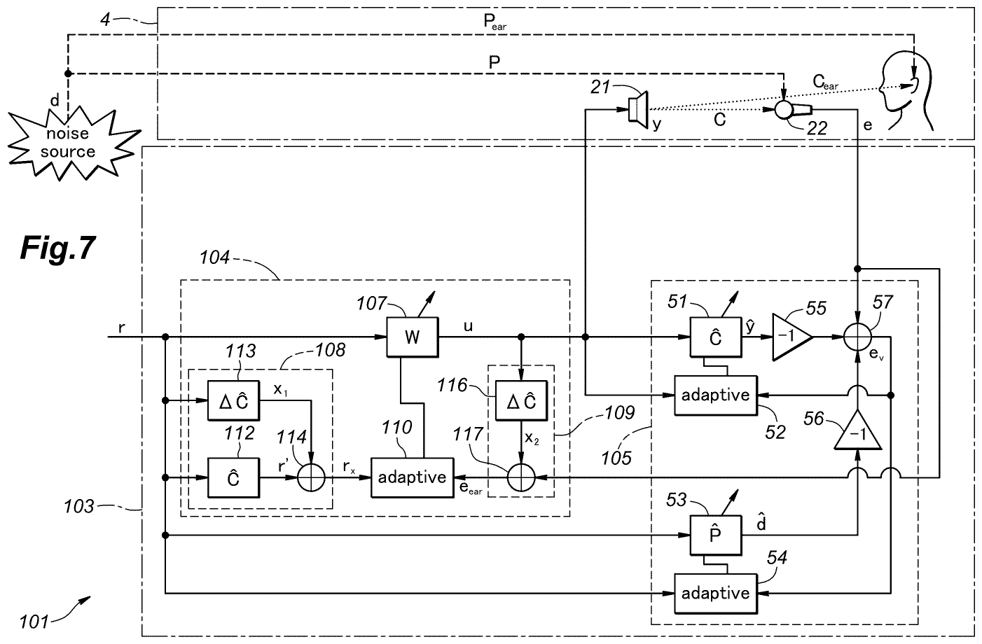

Next, an active noise reduction system 101 (hereinafter abbreviated as “the noise reduction system 101”) according to the third embodiment of the present invention will be described with reference to FIG. 7. Since the components other than a controller 103 are similar to those in the first embodiment, these components will be given the same reference numerals as those in the first embodiment in the drawings, and the descriptions thereof will be omitted.

### <Controller 103>

The controller 103 includes, as functional components thereof, a control signal generation unit 104 and a sound field learning unit 105. The sound field learning unit 105 is similar to the sound field learning unit 32 according to the first embodiment, and therefore the descriptions thereof will be omitted.

### <Control Signal Generation Unit 104>

The control signal generation unit 104 of the controller 103 includes a control filter unit 107, a reference signal correction unit 108, an error signal correction unit 109, and a control update unit 110. The control filter unit 107 is similar to the control filter unit 41 according to the first embodiment, and therefore the descriptions thereof will be omitted.

The reference signal correction unit 108 includes a secondary path filter unit 112, a first correction filter unit 113, and an adder 114.

The secondary path filter unit 112 includes a secondary path filter C\hat{ }. The secondary path filter C\hat{ } is similar to the secondary path filter C\hat{ } according to the first embodiment, and therefore the descriptions thereof will be omitted. The secondary path filter unit 112 applies a filtering process to the reference signal r by the secondary path filter C\hat{ }, thereby generating a correction reference signal r′. The secondary path filter unit 112 outputs the generated correction reference signal r′ to the adder 114.

The first correction filter unit 113 includes a correction filter ΔC\hat{ }. The correction filter ΔC\hat{ } is similar to the correction filter ΔC\hat{ } according to the first embodiment, and therefore the descriptions thereof will be omitted. The first correction filter unit 113 applies a filtering process to the reference signal r by the correction filter ΔC\hat{ }, thereby generating a first correction signal x₁. The first correction filter unit 113 outputs the generated first correction signal x₁ to the adder 114.

The adder 114 generates a correction reference signal rₓ by adding together the correction reference signal r′ output from the secondary path filter unit 112 and the first correction signal x₁ output from the first correction filter unit 113. The adder 114 outputs the generated correction reference signal rₓ to the control update unit 110.

In this manner, the reference signal correction unit 108 generates the correction reference signal rₓ by correcting the reference signal r by the secondary path filter C\hat{ } and the correction filter ΔC\hat{ }.

The error signal correction unit 109 includes a second correction filter unit 116 and an adder 117.

The second correction filter unit 116 includes the correction filter ΔC\hat{ }, similar to the first correction filter unit 113. The second correction filter unit 116 applies a filtering process to the control signal u by the correction filter ΔC\hat{ }, thereby generating a second correction signal x₂. The second correction filter unit 116 outputs the generated second correction signal x₂ to the adder 117.

The adder 117 generates a correction error signal eₑₐᵣ (the error signal at the ear position of the occupant) by adding together the error signal e (the error signal at the position of the error microphone 22) output from the error microphone 22 and the second correction signal x₂ output from the second correction filter unit 116. In other words, the adder 117 generates the correction error signal eₑₐᵣ by correcting the error signal e using the second correction signal x₂. The adder 117 outputs the generated correction error signal eₑₐᵣ to the control update unit 110.

The control update unit 110 adaptively updates the control filter W based on the correction reference signal rₓ output from the reference signal correction unit 108 and the correction error signal eₑₐᵣ output from the error signal correction unit 109. More specifically, the control update unit 110 adaptively updates the control filter W using an adaptive algorithm such as the LMS algorithm such that the correction error signal eₑₐᵣ is minimized.

### <The Adaptive Update of the Secondary Path Filter C\hat{ } and the Primary Path Filter P\hat{ }>

The adder 57 generates the virtual error signal eᵥ by adding together the canceling sound estimation signal y\hat{ } that has passed through the canceling sound estimation signal reversing unit 55, the noise estimation signal d\hat{ } that has passed through the noise estimation signal reversing unit 56, and the error signal e output from the error microphone 22. The adder 57 outputs the generated virtual error signal eᵥ to the secondary path update unit 52 and the primary path update unit 54.

The secondary path update unit 52 adaptively updates the secondary path filter C\hat{ } based on the control signal u and the virtual error signal eᵥ. More specifically, the secondary path update unit 52 adaptively updates the secondary path filter C\hat{ } using an adaptive algorithm such as the LMS algorithm such that the virtual error signal eᵥ is minimized.

The primary path update unit 54 adaptively updates the primary path filter P\hat{ } based on the reference signal r and the virtual error signal eᵥ. More specifically, the primary path update unit 54 adaptively updates the primary path filter P\hat{ } using an adaptive algorithm such as the LMS algorithm such that the virtual error signal eᵥ is minimized.

### <Action and Effect>

With reference to FIG. 2, in the above first embodiment, the controller 23 generates the virtual error signal eᵥ based on the correction error signal eₑₐᵣ (the error signal at the ear position of the occupant), and adaptively updates the secondary path filter C\hat{ } based on the virtual error signal eᵥ. Accordingly, the secondary path filter C\hat{ } after the adaptive update thereof converges to the transfer function Cₑₐᵣ of the occupant secondary path, and therefore the transfer function C of the microphone secondary path may not be accurately estimated.

In contrast, with reference to FIG. 7, in the present embodiment, the controller 103 generates the virtual error signal eᵥ based on the error signal e (the error signal at the position of the error microphone 22), and adaptively updates the secondary path filter C\hat{ } based on the virtual error signal eᵥ. Accordingly, the secondary path filter C\hat{ } after the adaptive update thereof converges to the transfer function C of the microphone secondary path. Accordingly, it is possible to more accurately estimate the transfer function C of the microphone secondary path, thereby improving the stability of noise reduction control.

### The Fourth Embodiment

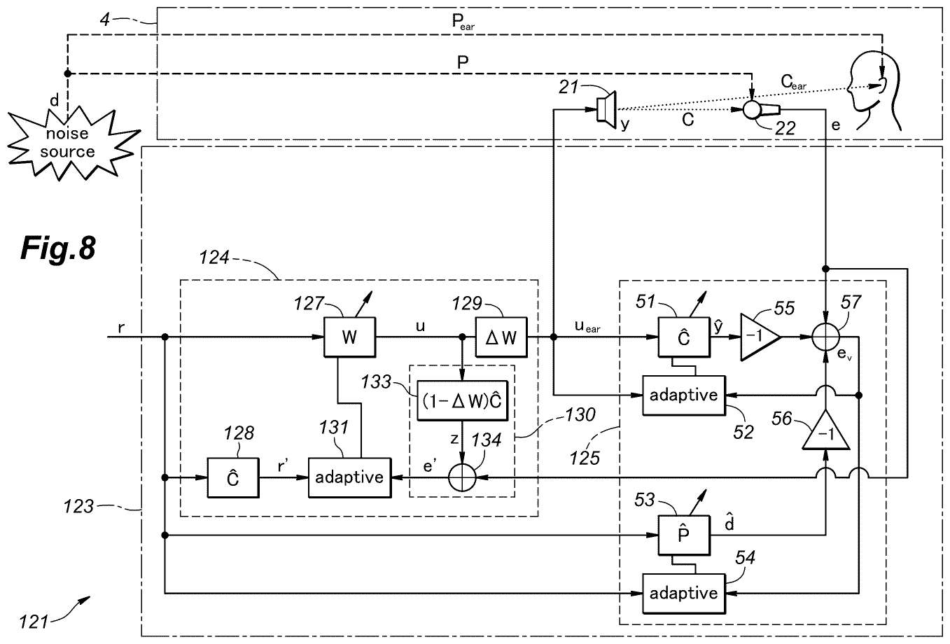

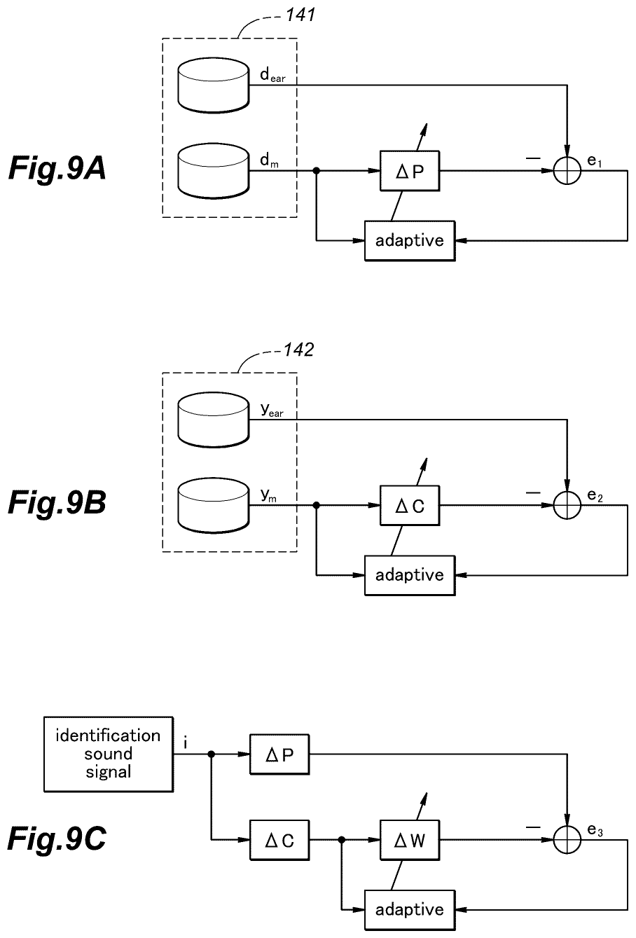

Next, an active noise reduction system 121 (hereinafter abbreviated as “the noise reduction system 121”) according to the fourth embodiment of the present invention will be described with reference to FIG. 8 and FIGS. 9A to 9C. Since the components other than a controller 123 are similar to those in the first embodiment, these components will be given the same reference numerals as those in the first embodiment in the drawings, and the descriptions thereof will be omitted.

With reference to FIG. 8, the controller 123 includes, as functional components thereof, a control signal generation unit 124 and a sound field learning unit 125. The sound field learning unit 125 is similar to the sound field learning unit 32 according to the first embodiment, and therefore the descriptions thereof will be omitted.

### <Control Signal Generation Unit 124>

The control signal generation unit 124 of the controller 123 includes a control filter unit 127, a secondary path filter unit 128, a control signal correction unit 129, a component removal unit 130, and a control update unit 131. The control filter unit 127 and the secondary path filter unit 128 are similar to the control filter unit 41 and the secondary path filter unit 42 according to the first embodiment, and therefore the descriptions thereof will be omitted.

The control signal correction unit 129 includes a correction filter ΔW. The correction filter ΔW is represented by the following formula (11).

$$Δ W = \frac{Δ P}{Δ C} \qquad ( 11 )$$

“ΔP” in the above formula (11) represents a ratio (hereinafter referred to as “the primary path characteristics ΔP”) of an estimation value of the transfer function Pₑₐᵣ of the occupant primary path to an estimation value of the transfer function P of the microphone primary path. The primary path characteristics ΔP are represented by the following formula (12).

$$Δ P = \frac{{\hat{P}}_{ear}}{\hat{P}} \qquad ( 12 )$$

“ΔC” in the above formula (11) represents a ratio (hereinafter referred to as “the secondary path characteristics ΔC”) of an estimation value of the transfer function Cₑₐᵣ of the occupant secondary path to an estimation value of the transfer function C of the microphone secondary path. The secondary path characteristics ΔC are represented by the following formula (13).

$$Δ C = \frac{{\hat{C}}_{ear}}{\hat{C}} \qquad ( 13 )$$

As is clear from the above formulae (11) to (13), the correction filter ΔW is a filter corresponding to both the primary path filter P\hat{ } and the secondary path filter C\hat{ }, and is a filter that represents a difference between the acoustic characteristics at the position of the error microphone 22 and the acoustic characteristics at the ear position of the occupant. The correction filter ΔW is composed of, for example, an FIR filter. In another embodiment, the correction filter ΔW may be composed of a SAN filter and the like. The correction filter ΔW is a fixed value that is set in advance.

The control signal correction unit 129 applies a filtering process to the control signal u by the correction filter ΔW, thereby generating a correction control signal uₑₐᵣ. In other words, the control signal correction unit 129 generates the correction control signal uₑₐᵣ by correcting the amplitude and phase of the control signal u by the correction filter ΔW. The control signal correction unit 129 outputs the generated correction control signal uₑₐᵣ to the speaker 21 and the sound field learning unit 125. Accordingly, the speaker 21 generates the canceling sound y according to the correction control signal uₑₐᵣ output from the control signal correction unit 129.

The component removal unit 130 includes a removal filter unit 133 and an adder 134.

The removal filter unit 133 includes a removal filter (1−ΔW)C\hat{ }. The removal filter (1−ΔW)C\hat{ } is composed of, for example, an FIR filter. In another embodiment, the removal filter (1−ΔW)C\hat{ } may be composed of a SAN filter and the like.

The removal filter unit 133 applies a filtering process to the control signal u by the removal filter (1−ΔW)C\hat{ }, thereby generating a removal signal z. The removal filter unit 133 outputs the generated removal signal z to the adder 134.

The adder 134 generates a correction error signal e′ by adding together the error signal e output from the error microphone 22 and the removal signal z output from the removal filter unit 133. In other words, the adder 134 generates the correction error signal e′ by correcting the error signal e using the removal signal z. The adder 134 outputs the generated correction error signal e′ to the control update unit 131.

The control update unit 131 adaptively updates the control filter W based on the correction reference signal r′ output from the secondary path filter unit 128 and the correction error signal e′ output from the component removal unit 130. More specifically, the control update unit 131 adaptively updates the control filter W using an adaptive algorithm such as the LMS algorithm such that the correction error signal e′ is minimized.

### <The Adaptive Update of the Secondary Path Filter C\hat{ } and the Primary Path Filter P\hat{ }>

The canceling sound estimation signal generation unit 51 applies a filtering process to the correction control signal uₑₐᵣ by the secondary path filter C\hat{ }, thereby generating a canceling sound estimation signal y\hat{ }. The secondary path update unit 52 adaptively updates the secondary path filter C\hat{ } based on the correction control signal uₑₐᵣ and the virtual error signal eᵥ. In other respects, the method of the adaptive update of the secondary path filter C\hat{ } and the primary path filter P\hat{ } in the present embodiment is similar to the method of the adaptive update of the secondary path filter C\hat{ } and the primary path filter P\hat{ } in the third embodiment, and therefore the descriptions thereof will be omitted.

### <The Identification Method of the Correction Filter ΔW>

Next, an example of the identification method of the correction filter ΔW will be described with reference to FIGS. 9A to 9C.

First, in a manner similar to the second embodiment, a microphone noise signal dₘ and an occupant noise signal dₑₐᵣ are recorded in a first signal recording portion 141. Further, in a manner similar to the first embodiment, a microphone canceling sound signal yₘ and an occupant canceling sound signal year are recorded in a second signal recording portion 142.

Next, as shown in FIG. 9A, the primary path characteristics ΔP are identified based on the microphone noise signal dₘ and the occupant noise signal dₑₐᵣ recorded in the first signal recording portion 141. More specifically, the primary path characteristics ΔP are adaptively updated such that an error signal e₁ between the microphone noise signal dₘ to which a filtering process is applied using the primary path characteristics ΔP and the occupant noise signal dₑₐᵣ is minimized.

Next, as shown in FIG. 9B, the secondary path characteristics ΔC are identified based on the microphone canceling sound signal yₘ and the occupant canceling sound signal year recorded in the second signal recording portion 142. More specifically, the secondary path characteristics ΔC are adaptively updated such that an error signal e₂ between the microphone canceling sound signal yₘ to which a filtering process is applied using the secondary path characteristics ΔC and the occupant canceling sound signal year is minimized.

Next, as shown in FIG. 9C, the correction filter ΔW is identified based on the identified primary path characteristics ΔP and secondary path characteristics ΔC. More specifically, the correction filter ΔW is adaptively updated such that an error signal e₃ between an identification sound signal i (a white noise, and the like) to which a filtering process is applied using the secondary path characteristics ΔC and the correction filter ΔW and the identification sound signal i to which a filtering process is applied using the primary path characteristics ΔP is minimized.

### <Action and Effect>

The error signal e is a signal generated by adding together the canceling sound y and the noise d. Accordingly, the error signal e is represented by the following formula (14).

$$e = d + y = d + u * Δ W * C \qquad ( 14 )$$

The correction error signal e′ is a signal generated by adding together the error signal e and the removal signal z. Accordingly, the correction error signal e′ is represented by the following formula (15).

$${e}^{′} = e + z = e + u * ( 1 - Δ W ) * \hat{C} \qquad ( 15 )$$

The following formula (16) is acquired from the above formulae (14) and (15).

$${e}^{′} = d + u * Δ W * C + u * \hat{C} - u * Δ W * \hat{C} = d + u * \hat{C} \qquad ( 16 )$$

As is clear from the above formula (16), the controller 123 generates the correction error signal e′ by removing a component of the correction filter ΔW from the error signal e.

From the above formula (16), the following formula (17) can be acquired.

$${e}^{′} = r * P + r * W * \hat{C} \qquad ( 17 )$$

The controller 123 adaptively updates the control filter W such that the correction error signal e′ is minimized. At this time, since the correction error signal e′ approaches zero, the following formula (18) is acquired from the above formula (17).

$$W = - \frac{P}{\hat{C}} \qquad ( 18 )$$

As is clear from the above formula (18), the value of the control filter W converges to the characteristics for controlling the noise d at the position of the error microphone 22.

On the other hand, the speaker 21 is controlled by an equivalent filter W×ΔW acquired by multiplying the control filter W by the correction filter ΔW. This equivalent filter W×ΔW is represented by the following formula (19).

$$W \times Δ W = - \frac{P}{\hat{C}} \times \frac{Δ P}{Δ C} = - \frac{{\hat{P}}_{ear}}{{\hat{C}}_{ear}} \qquad ( 19 )$$

As is clear from the above formula (19), the equivalent filter W×ΔW has the characteristics for controlling the noise d at the ear position of the occupant. Accordingly, it is possible to effectively reduce the noise d at the ear position of the occupant.

Further, the controller 123 generates the virtual error signal eᵥ based on the error signal e (the error signal at the position of the error microphone 22), and adaptively updates the secondary path filter C\hat{ } based on the virtual error signal eᵥ. Accordingly, the secondary path filter C\hat{ } after the adaptive update thereof converges to the transfer function C of the microphone secondary path. Accordingly, similarly to the third embodiment, it is possible to accurately estimate the transfer function C of the microphone secondary path, thereby improving the stability of noise reduction control.

### Modifications

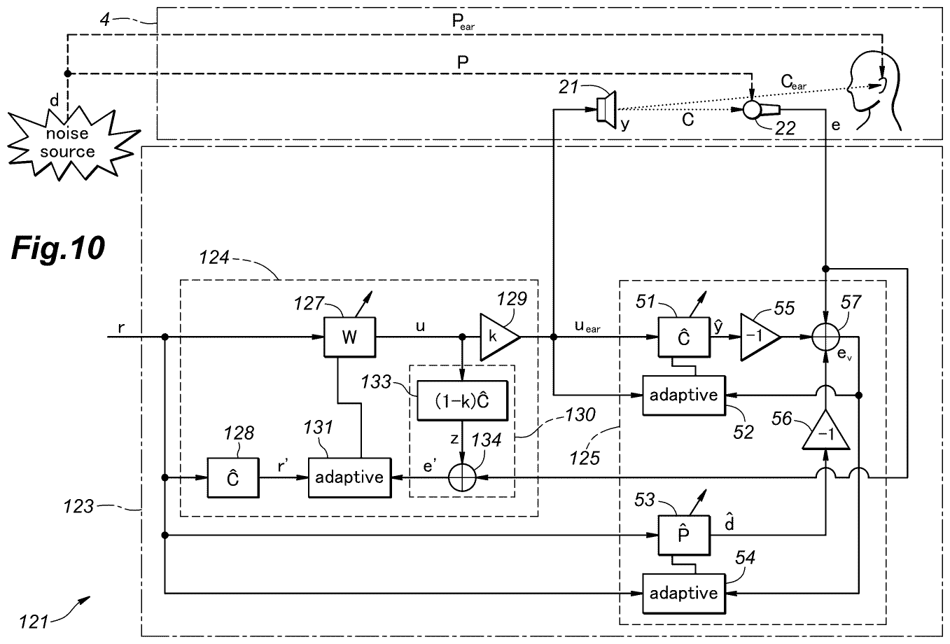

In the above fourth embodiment, the control signal correction unit 129 includes the correction filter ΔW (FIR filter) that corrects the amplitude and phase of the control signal u. With reference to FIG. 10, in another embodiment, the control signal correction unit 129 may include a correction filter K (multiplier) that corrects only the amplitude of the control signal u. Accordingly, it is possible to save the memory capacity of the controller 123 as compared to a case where the control signal correction unit 129 is composed of the correction filter ΔW. Further, in a case where the control signal correction unit 129 includes the correction filter K, the removal filter unit 133 may include a removal filter (1−K)C\hat{ } for removing a component of the correction filter K from the error signal e.

The correction filter K is a real number for adjusting the magnitude of the canceling sound y. For example, in a case where the correction filter K is set to 2, the canceling sound y for controlling the noise d at the position of the error microphone 22 is amplified double. The correction filter K, like the correction filter ΔW, is a filter corresponding to both the primary path filter P\hat{ } and the secondary path filter C\hat{ }, and is a filter that represents the difference between the acoustic characteristics at the position of the error microphone 22 and the acoustic characteristics at the ear position of the occupant.

In the above first to fourth embodiments, the noise reduction systems 1, 81, 101, and 121 are applied to the vehicle cabin 4 of the vehicle 3. In another embodiment, the noise reduction systems 1, 81, 101, and 121 may be applied to an interior space of a moving object other than the vehicle 3 (for example, a ship or an aircraft), or the noise reduction systems 1, 81, 101, and 121 may be applied to an interior space of a fixed object (for example, a house).

Concrete embodiments of the present invention have been described in the foregoing, but the present invention should not be limited by the foregoing embodiments and various modifications and alterations are possible within the scope of the present invention.

1. An active noise reduction system, comprising:
a speaker configured to output a canceling sound for canceling a noise;
an error microphone configured to generate an error signal based on the noise and the canceling sound; and
a controller configured to control the speaker based on the error signal,
wherein the controller includes:
a control filter configured to generate a control signal for controlling the speaker;
a secondary path filter that represents an estimation value of a transfer function of a secondary path from the speaker to the error microphone; and
a correction filter that represents a difference between acoustic characteristics at a position of the error microphone and acoustic characteristics at a position of a user, and
the controller is configured to
generate a correction signal by the correction filter,
generate a correction error signal by correcting the error signal using the correction signal,
adaptively update the control filter based on the correction error signal,
generate a canceling sound estimation signal by the secondary path filter based on the control signal, and
adaptively update the secondary path filter based on the canceling sound estimation signal and the correction error signal.

2. The active noise reduction system according to claim 1, wherein the controller further includes a primary path filter that represents an estimation value of a transfer function of a primary path from a noise source to the error microphone, and
the correction filter includes:
a first correction filter corresponding to the primary path filter; and
a second correction filter corresponding to the secondary path filter.

3. An active noise reduction system, comprising:
a speaker configured to output a canceling sound for canceling a noise;
an error microphone configured to generate an error signal based on the noise and the canceling sound; and
a controller configured to control the speaker based on the error signal,
wherein the controller includes:
a control filter configured to generate a control signal for controlling the speaker;
a secondary path filter that represents an estimation value of a transfer function of a secondary path from the speaker to the error microphone; and
a correction filter that represents a difference between acoustic characteristics at a position of the error microphone and acoustic characteristics at a position of a user, and
the controller is configured to
generate a correction signal by the correction filter,
generate a correction error signal by correcting the error signal using the correction signal,
acquire a reference signal corresponding to the noise,
generate a correction reference signal by the secondary path filter and the correction filter based on the reference signal,
adaptively update the control filter based on the correction error signal and the correction reference signal,
generate a canceling sound estimation signal by the secondary path filter based on the control signal, and
adaptively update the secondary path filter based on the canceling sound estimation signal.

4. The active noise reduction system according to claim 3, wherein the controller is configured to
generate a virtual error signal based on the error signal and the canceling sound estimation signal, and
adaptively update the secondary path filter such that the virtual error signal is minimized.

5. An active noise reduction system, comprising:
a speaker configured to output a canceling sound for canceling a noise;
an error microphone configured to generate an error signal based on the noise and the canceling sound; and
a controller configured to control the speaker based on the error signal,
wherein the controller includes:
a control filter configured to generate a control signal for controlling the speaker;
a secondary path filter that represents an estimation value of a transfer function of a secondary path from the speaker to the error microphone; and
a correction filter that represents a difference between acoustic characteristics at a position of the error microphone and acoustic characteristics at a position of a user, and
the controller is configured to
generate a correction control signal by correcting the control signal by the correction filter,
output the correction control signal to the speaker,
generate a canceling sound estimation signal by the secondary path filter based on the correction control signal, and
adaptively update the secondary path filter based on the canceling sound estimation signal.

6. The active noise reduction system according to claim 5, wherein the controller is configured to
generate a correction error signal by removing a component of the correction filter from the error signal, and
adaptively update the control filter based on the correction error signal.

7. The active noise reduction system according to claim 5, wherein the controller further includes a primary path filter that represents an estimation value of a transfer function of a primary path from a noise source to the error microphone, and
the correction filter corresponds to both the primary path filter and the secondary path filter.
